(19) United States
(12) Patent Application Publication
(10) Pub. No.: US 2002/0130703 A1
(43) Pub. Date: Sep. 19, 2002

(54) Charge pumping circuit

(76) Inventor: Hong-Ping Tsai, Kaohsiung (TW)

Correspondence Address: J.C. Patents, Inc., 4 Venture, Suite 250, Irvine, CA, 92618, US

(21) Appl. No.: 09/962,713

(22) Filed: Sep. 24, 2001

(30) Foreign Application Priority Data
Mar. 16, 2001 (TW) 90106158

(51) Int. Cl. G05F 1/10

(52) U.S. Cl. 327/536

(57) ABSTRACT

A charge pumping circuit for reducing body effect and boosting charging performance. Two of pull-up circuits are employed so that the source terminal of the NMOS transistor in each charging circuit stage is connected to the drain terminal of a corresponding NMOS transistor in the next stage. Furthermore, the gate terminal of the NMOS transistor of a first group pull-up circuit is connected to the source terminal of the NMOS transistor of a second group pull-up circuit. Similarly, the gate terminal of the NMOS transistor of the second group pull-up circuit is connected to the source terminal of the NMOS transistor of the first group pull-up circuit. In addition, a CMOS circuit may be employed to control the NMOS transistor in each stage more efficiently.

### CROSS-REFERENCE TO RELATED APPLICATION

This application claims the priority benefit of Taiwan application serial no. 90106158, filed on Mar. 16, 2001.

### BACKGROUND OF THE INVENTION

1. Field of Invention

The present invention relates to a charge pumping circuit. More particularly, the present invention relates to a charge pumping circuit with minimized body effect so that loss in gain at each charge pumping stage is reduced.

2. Description of Related Art

Charge pumping circuits have many applications inside electrically erasable programmable read only memories (EEPROM). FIG. 1 is a circuit diagram of a conventional Dickson type charge pumping circuit. The charge pumping circuit includes an input stage 10, a plurality of pull-up stages (12, 14, 16, 18 and 20) and an output stage 22. The input stage 10 consists of an NMOS transistor 24. The drain terminal and the gate terminal of the NMOS transistor 24 are connected together for receiving an input voltage Vin. The source terminal of the NMOS transistor 24 is connected to a first pull-up stage 12. Each pull-up stage consists of an NMOS transistor and a coupled capacitor. Here, a typical pull-up stage such as the pull-up stage 12 and its internal connections are described. The drain terminal and the gate terminal of the NMOS transistor 26 and one terminal of the coupled capacitor 28 are connected together. The source terminal of the NMOS transistor 26 is serially connected to the drain terminal of the transistor in the next pull-up stage 14. A first clocking signal Vphi1 is input to the other terminal of the coupled capacitor 28. Two types of input clocking signal are used. As shown in FIG. 2, one type of clocking signal (Vphi1) is applied to the odd-numbered pull-up stages (for example, 12, 16, and 20) while the other type of clocking signal (Vphi2) is applied to the even-numbered pull-up stages (for example, 14 and 18). FIG. 2 is a timing diagram showing the first and the second clocking signal applied to the circuit in FIG. 1. As shown in FIG. 2, the first clocking signal Vphi1 and the second clocking signal Vphi2 are non-overlapping complementary signals having amplitude of Vdd. The output stage 22 has a capacitor Cout with a larger capacitance.

When the first clocking signal Vphi1 rises to a high voltage, due to a coupling with the coupled capacitor, voltage at the drain terminals of the NMOS transistor in the odd-numbered pull-up stages (for example, 12, 16 and 20) is pulled up. Thereafter, the voltage is transferred to the even-numbered pull-up stages. As the second clocking signal Vphi2 rises to a high voltage, due to the coupling of the coupled capacitor, voltage at the drain terminals of the NMOS transistor in the even-numbered pull-up stages (for example, 14 and 18) is pulled up to an even higher level. Similarly, the voltage is subsequently transferred to the odd-number pull-up stages. Ultimately, voltage is pulled up to a desired level.

However, voltage transferred from one pull-up stage to the next is affected by threshold voltage (V_{TE}) of the transistor in a pull-up stage. Hence, maximum gain of each pull-up stage is only VDD—VTh. In addition, since the drain terminal and the gate terminal of the NMOS transistor are connected together in the saturated region, body effect is also dominant leading to a lowering of the gain in each pull-up stage. For example, if the input voltage to each pull-up stage is V_{DD}=3V, the first pull-up stage is pulled up to 2.3V only due to a threshold voltage V_{TH}=0.7V. In the subsequent stages, pull-up voltage is even lower due to body effect and rises to a voltage level not exceeding 2V, for example.

### SUMMARY OF THE INVENTION

Accordingly, one object of the present invention is to provide a charge pumping circuit capable of reducing body effect and increasing charge-pumping efficiency.

To achieve these and other advantages and in accordance with the purpose of the invention, as embodied and broadly described herein, the invention provides a charge pumping circuit. The charge pumping circuit includes a first pull-up section having a first input stage circuit, a plurality of first group pull-up circuits and a first output stage circuit and a second pull-up section having a second input stage circuit, a plurality of second group pull-up circuits and a second output stage circuit.

A first terminal of the first input stage circuit and the second stage input circuit receives an input voltage while the other terminal are connected to the first group pull-up circuit and the second group pull-up circuit, respectively.

Each first group pull-up circuit and each second group pull-up circuit comprises an NMOS transistor and a first coupled capacitor. The drain terminal of the NMOS transistor is connected to a terminal of the first coupled capacitor. The source terminal of each NMOS transistor is serially connected to the drain terminal of the transistor in a subsequent stage. The gate terminal of the NMOS transistor in the first group pull-up circuit is connected to the source terminal of the NMOS transistor of a corresponding second group pull-up circuit. The gate terminal of the NMOS transistor of the second group pull-up circuit is connected to the source terminal of the NMOS transistor of the corresponding first group pull-up circuit. A first clocking signal is applied to the other terminal of all first coupled capacitors in the odd-numbered first group pull-up circuits and the even-numbered second group pull-up circuits. Similarly, a second clocking signal is applied to the other terminal of all first coupled capacitors in the even-numbered first group pull-up circuits and the odd-numbered second group pull-up circuits. The first clocking signal and the second clocking signal are non-overlapping complementary signals.

The first output stage circuit and the second output stage circuit both comprise an NMOS transistor and a second coupled capacitor. The drain terminal of the NMOS transistor is coupled to its gate terminal and one of the terminals of the second coupled capacitor. The source terminal of the NMOS transistor in the first output stage circuit and the second output stage circuit are connected together to form an output terminal. The other terminal of the second coupled capacitor of the first output stage circuit and the second output stage circuit receive the first clocking signal and the second clocking signal, respectively.

The first input stage circuit and the second input stage circuit each comprise an NMOS transistor. The drain terminal and the gate terminal of the NMOS transistor are connected together for receiving an input voltage. The source terminal of the NMOS transistor of the first input stage circuit and the second input stage circuit are connected to the drain terminal of the first NMOS transistor of the first group pull-up circuits and the second group pull-up circuits, respectively.

This invention also provides a second charge pumping circuit. The charge pumping circuit includes a first pull-up circuit section having a first input stage circuit, a plurality of first group pull-up circuits and a first output stage circuit and a second pull-up circuit section having a second input stage circuit, a plurality of second group pull-up circuits and a second output stage circuit.

One of the terminals of the first input stage circuit and the second input stage circuit receive an input voltage while the other terminal is connected to the first group pull-up circuits and the second group pull-up circuits.

Each first group pull-up circuit and each second group pull-up circuit comprise an NMOS transistor, a CMOS circuit and a first coupled capacitor. The drain terminal of the NMOS transistor is connected to its substrate, one terminal of the first coupled capacitor and a loading terminal of the CMOS circuit. The source terminal of each NMOS transistor is serially connected to the drain terminal of a next stage transistor. The gate terminal of the NMOS transistor is connected to an output terminal of the CMOS circuit. A control terminal of the CMOS circuit of the first group pull-up circuit is connected to the drain terminal of the NMOS transistor of a corresponding second group pull-up circuit. A voltage terminal of the CMOS circuit of the first group pull-up circuit is connected to the source terminal of the NMOS transistor of a corresponding second group pull-up circuit. A control terminal of the CMOS circuit of the second group pull-up circuit is connected to the drain terminal of the NMOS transistor of a corresponding first group pull-up circuit. A voltage terminal of the CMOS circuit of the second group pull-up circuit is connected to the source terminal of the NMOS transistor of a corresponding first group pull-up circuit. A first clocking signal is applied to the other terminal of all first coupled capacitors in the odd-numbered first group pull-up circuits and the even-numbered second group pull-up circuits. Similarly, a second clocking signal is applied to the other terminal of all first coupled capacitors in the even-numbered first group pull-up circuits and the odd-numbered second group pull-up circuits. The first clocking signal and the second clocking signal are non-overlapping complementary signals.

The first output stage circuit and the second output stage circuit both comprise an NMOS transistor and a second coupled capacitor. The drain terminal of the NMOS transistor is coupled to its substrate, its gate terminal and one of the terminals of the second coupled capacitor. The source terminal of the NMOS transistor in the first output stage circuit and the second output stage circuit are connected together to form an output terminal. The other terminal of the second coupled capacitor of the first output stage circuit and the second output stage circuit receive the first clocking signal and the second clocking signal, respectively.

The CMOS circuit comprises a PMOS transistor and an NMOS transistor. The gate terminal of the PMOS transistor and the NMOS transistor are connected together to form a control terminal. The drain terminal of the PMOS transistor and the NMOS transistor are connected together to form an output terminal. The source terminal of the PMOS transistor serves as a voltage terminal and the source terminal of the NMOS transistor serves as a loading terminal.

This invention also provides a third charge pumping circuit. The charge pumping circuit includes a first pull-up circuit section having a first input stage circuit, a plurality of first group pull-up circuits and a first output stage circuit and a second pull-up circuit section having a second input stage circuit, a plurality of second group pull-up circuits and a second output stage circuit.

One of the terminals of the first input stage circuit and the second input stage circuit receive an input voltage while the other terminal is connected to the first group pull-up circuits and the second group pull-up circuits.

Each first group pull-up circuit and each second group pull-up circuit comprises a PMOS transistor, a CMOS circuit and a first coupled capacitor. The source terminal of the PMOS transistor is connected to a control terminal of the CMOS circuit and a terminal of the first coupled capacitor. The drain terminal and the substrate terminal of the PMOS transistor as well as a voltage terminal of the CMOS circuit are connected together. The drain terminal of each PMOS transistor is connected to the source terminal of a next stage PMOS transistor. The gate terminal of the PMOS transistor is connected to an output terminal of the CMOS circuit. A loading terminal of the CMOS circuit of the first group pull-up circuit is connected to the source terminal of the PMOS transistor of a corresponding second group pull-up circuit. A loading terminal of the CMOS circuit of the second group pull-up circuit is connected to the source terminal of the PMOS transistor of a corresponding first group pull-up circuit. A first clocking signal is applied to the other terminal of all first coupled capacitors in the odd-numbered first group pull-up circuits and the even-numbered second group pull-up circuits. Similarly, a second clocking signal is applied to the other terminal of all first coupled capacitors in the even-numbered first group pull-up circuits and the odd-numbered second group pull-up circuits. The first clocking signal and the second clocking signal are non-overlapping complementary signals.

The first output stage circuit and the second output stage circuit both comprise a PMOS transistor and a second coupled capacitor. The source terminal of the PMOS transistor is coupled to one of the terminals of the second coupled capacitor. The source terminal, the substrate and the gate terminal of the PMOS transistor and one terminal of the second coupled capacitor are connected together. The drain terminal of the PMOS transistor in the first output stage circuit and the second output stage circuit are connected together to form an output terminal. The other terminal of the second coupled capacitor of the first output stage circuit and the second output stage circuit receive the first clocking signal and the second clocking signal, respectively.

The first input stage circuit and the second input stage circuit are each constructed from a PMOS transistor. The source terminal of the PMOS transistor receives an input voltage. The drain terminal and the gate terminal of the PMOS transistor in the first input stage circuit and the second input stage circuit are connected together. The drain terminal of the PMOS transistor in the first input stage circuit and the second input stage circuit are connected to the first group pull-up circuit and the second group pull-up circuit, respectively.

This invention also provides a fourth charge pumping circuit. The charge pumping circuit includes a first pull-up circuit section having a first input stage circuit, a plurality of first group pull-up circuits and a first output stage circuit and a second pull-up circuit section having a second input stage circuit, a plurality of second group pull-up circuits and a second output stage circuit.

One of the terminals of the first input stage circuit and the second input stage circuit receive an input voltage while the other terminal is connected to the first group pull-up circuits and the second group pull-up circuits. Each first group pull-up circuit and each second group pull-up circuit comprises an NMOS transistor, a CMOS circuit and a first coupled capacitor. The drain terminal of the NMOS transistor is connected to a control terminal of the CMOS circuit and one of the terminals of the first coupled capacitor. The source terminal of the NMOS transistor is connected to the substrate terminal of the NMOS transistor and a loading terminal of the CMOS circuit. The source terminal of each PMOS transistor is serially connected to the drain terminal of a corresponding next stage NMOS transistor. The gate terminal of the NMOS transistor is connected an output terminal of the CMOS circuit. A voltage terminal of the CMOS circuit in the first group pull-up circuit is connected to the drain terminal of the NMOS transistor of a corresponding second group pull-up circuit. A voltage terminal of the CMOS circuit in the second group pull-up circuit is connected to the drain terminal of the NMOS transistor of a corresponding first group pull-up circuit. A first clocking signal is applied to the other terminal of all first coupled capacitors in the odd-numbered first group pull-up circuits and the even-numbered second group pull-up circuits. Similarly, a second clocking signal is applied to the other terminal of all first coupled capacitors in the even-numbered first group pull-up circuits and the odd-numbered second group pull-up circuits. The first clocking signal and the second clocking signal are non-overlapping complementary signals.

The first output stage circuit and the second output stage circuit both comprise of an NMOS transistor and a second coupled capacitor. The drain terminal of the NMOS transistor is connected to one terminal of the second coupled capacitor. The drain terminal, the substrate terminal and the gate terminal of the NMOS transistor are connected together. The source terminal of the NMOS transistor in the first output stage circuit and the second output stage circuit are connected together to form an output terminal. The other terminal of the second coupled capacitor of the first output stage circuit and the second output stage circuit receive the first clocking signal and the second clocking signal, respectively.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a circuit diagram of a conventional Dickson type charge-pumping circuit;

FIG. 2 is a timing diagram showing the first and the second clocking signal applied to the circuit in FIG. 1;

FIG. 3 is schematic diagram of a charge pumping circuit according to a first preferred embodiment of this invention;

FIGS. 4A to 4E are a series of circuit diagrams showing the front end operating stages of the charge pumping circuit shown in FIG. 3;

FIG. 5 is schematic diagram of a charge pumping circuit according to a second preferred embodiment of this invention;

FIG. 6 is schematic diagram of a charge pumping circuit according to a third preferred embodiment of this invention; and

FIG. 7 is schematic diagram of a charge pumping circuit according to a fourth preferred embodiment of this invention.

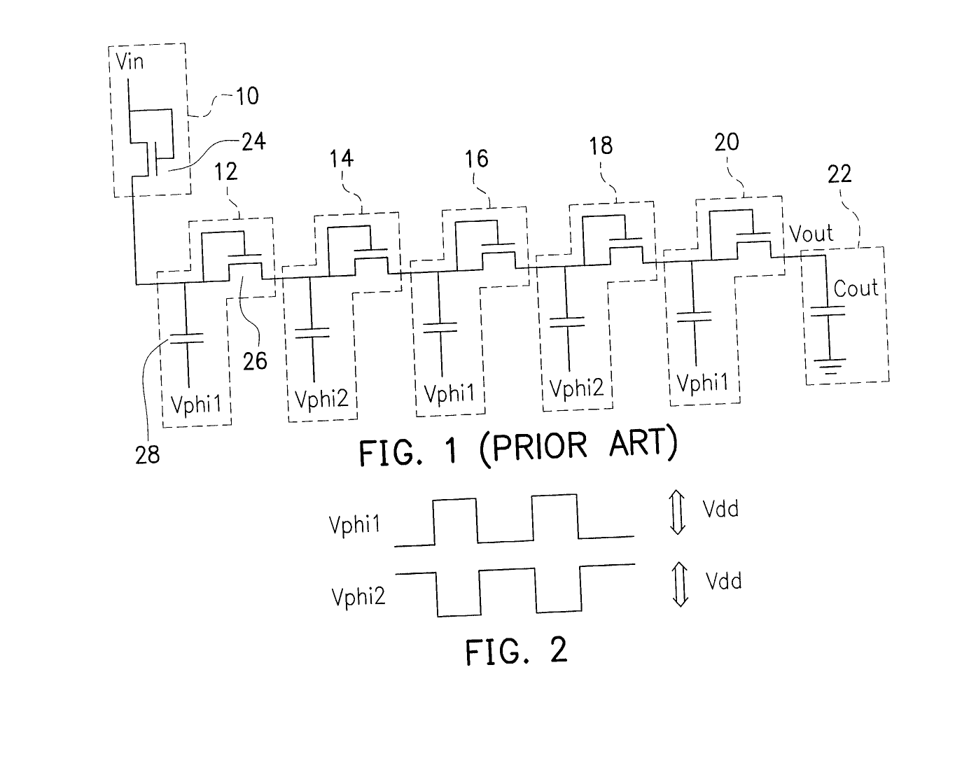

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 3 is schematic diagram of a charge pumping circuit according to a first preferred embodiment of this invention. As shown in FIG. 3, the charge pumping circuit includes a first pull-up circuit section 30 and a second pull-up circuit section 32. The first pull-up circuit section 30 further includes a first input stage circuit 34, a plurality of first group pull-up circuits (such as 36 and 38) and a first output stage circuit 40. Similarly, the second pull-up circuit section 32 includes a second input stage circuit 42, a plurality of second group pull-up circuits (such as 44 and 46) and a second output stage circuit 48.

The first input stage circuit 34 and the second input stage circuit 42 are identical in structure. Each of the first and the second stage circuits is built from an NMOS transistor. The drain terminal and the gate terminal of the NMOS transistor 50 inside the first input stage circuit 34, for example, are connected together for receiving an input voltage Vin. The source terminal of the NMOS transistor 50 is connected to the drain terminal of a first NMOS transistor 52 inside the first group pull-up circuit 36. Similarly, the drain terminal and the gate terminal of the NMOS transistor 54 inside the second input stage circuit 42 are connected together for receiving the input voltage Vin. The source terminal of the NMOS transistor 54 is connected to the drain terminal of a first NMOS transistor 56 inside the second group pull-up circuit 44.

Each of the plurality of first group pull-up circuits (36 and 38) and the plurality of second group pull-up circuits (44 and 46) has an identical structure. The following is a detailed description of the first group pull-up circuit 36 and a corresponding second group pull-up circuit 44. The first group pull-up circuit 36 comprises an NMOS transistor 52 and a first coupled capacitor 58. The drain terminal of the NMOS transistor 52 is connected to the source terminal of the NMOS transistor 50 and a terminal of the first coupled capacitor 58. The source terminal of the NMOS transistor 52 is serially connected to the drain of an NMOS transistor 60 in the next pull-up stage and so on so that the plurality of NMOS transistors are serially connected together. The gate terminal of the NMOS transistor 52 is connected to the source terminal of an NMOS transistor 56 of the second group pull-up circuit 44. The other terminal of the first coupled capacitor 58 receives a first clocking signal Vphi1.

The second group pull-up circuit 44 comprises the NMOS transistor 56 and a first coupled capacitor 62. The drain terminal of the NMOS transistor 56 is connected to the source terminal of the NMOS transistor 54 and a terminal of the second coupled capacitor 62. The source terminal of the NMOS transistor 56 is serially connected to the drain of an NMOS transistor 64 in the next pull-up stage and so on so that the plurality of NMOS transistors are serially connected together. The gate terminal of the NMOS transistor 56 is connected to the source terminal of an NMOS transistor 52 of the first group pull-up circuit 36. The other terminal of the first coupled capacitor 62 receives a second clocking signal Vphi2.

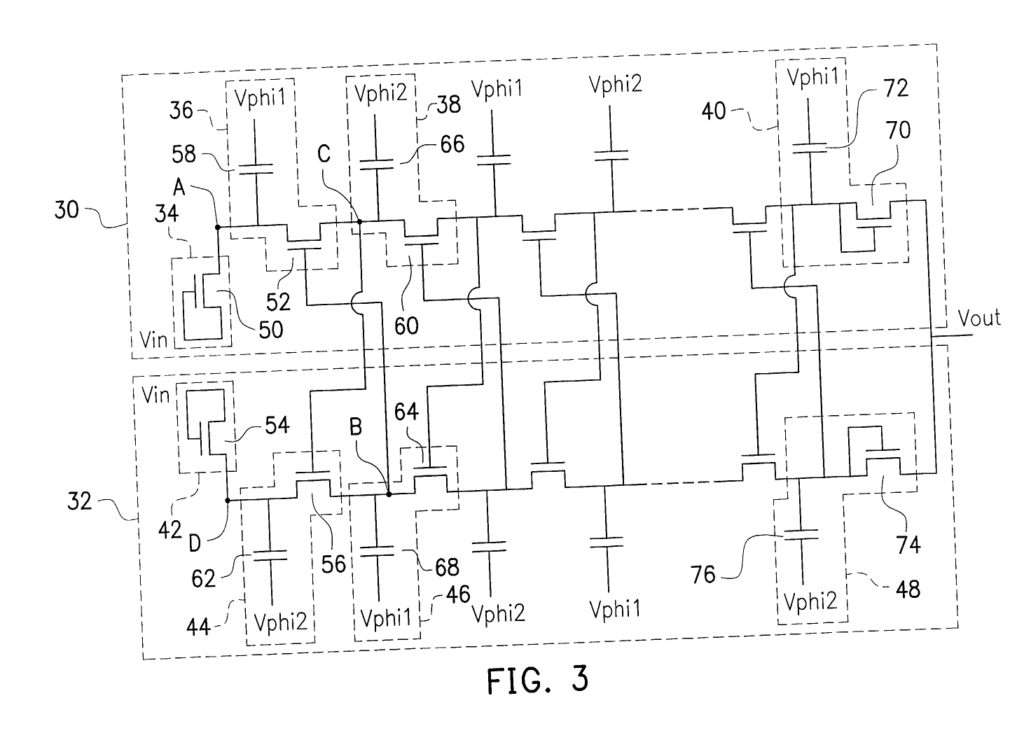

The first clocking signal Vphi1 is applied to all odd-numbered (1, 3, 5, . . . ) first coupled capacitor (for example, 58) of the first group pull-up circuit (for example, 36) and to all even-numbered (2, 4, 6, . . . ) first coupled capacitor (for example, 68) of the second group pull-up circuit (for example, 46). Similarly, the second clocking signal Vphi2 is applied to all even-numbered (2, 4, 6 . . . ) first coupled capacitor (for example, 66) of the first group pull-up circuit (for example, 38) and to all odd-numbered (1, 3, 5, . . . ) first coupled capacitor (for example, 62) of the second group pull-up circuit (for example, 44). Timing diagram of the first and the second clocking signal is similar to the one shown in FIG. 2. In other words, the first clocking signal Vphi1 and the second clocking signal Vphi2 are non-overlapping complementary signals.

The first output stage circuit 40 comprises an NMOS transistor 70 and a second coupled capacitor 72. The drain terminal of the NMOS transistor 70 is connected to its gate terminal and a terminal of the second coupled capacitor 72. The other terminal of the second coupled capacitor 72 receives the first clocking signal Vphi1. The second output stage circuit 48 also comprises an NMOS transistor 74 and a second coupled capacitor 76. The drain terminal of the NMOS transistor 74 is connected to its gate terminal and a terminal of the second coupled capacitor 76. The other terminal of the second coupled capacitor 76 receives the second clocking signal Vphi2. The source terminal of the NMOS transistor 70 and the NMOS transistor 74 are connected together to serve as an output terminal.

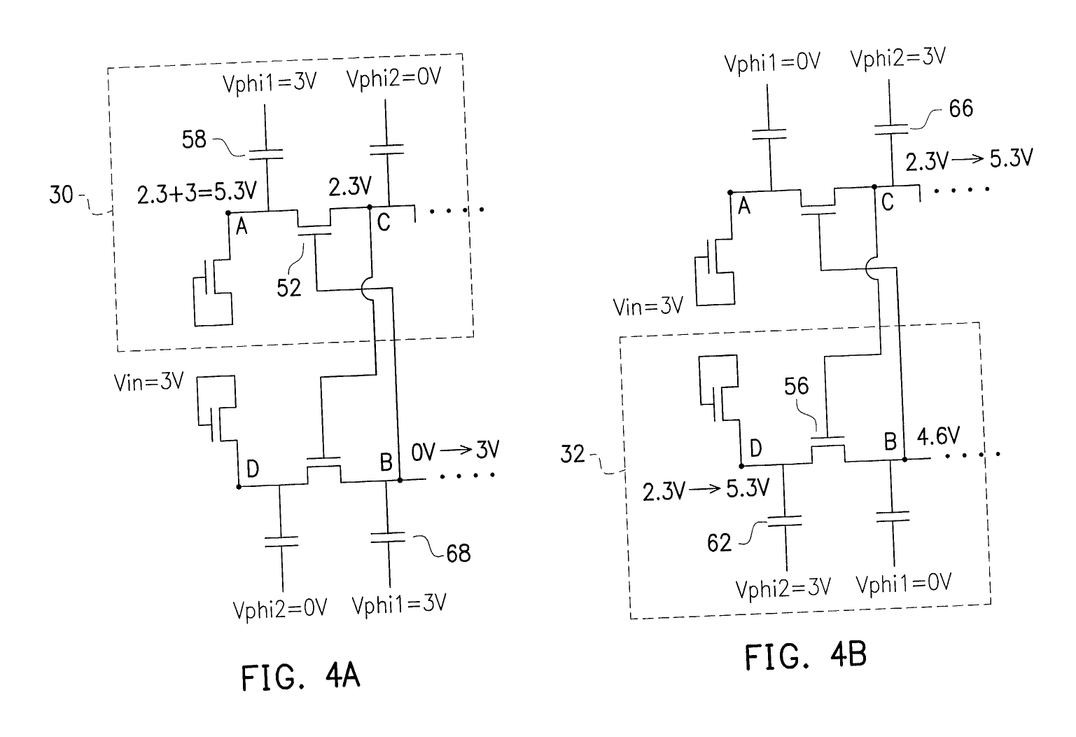

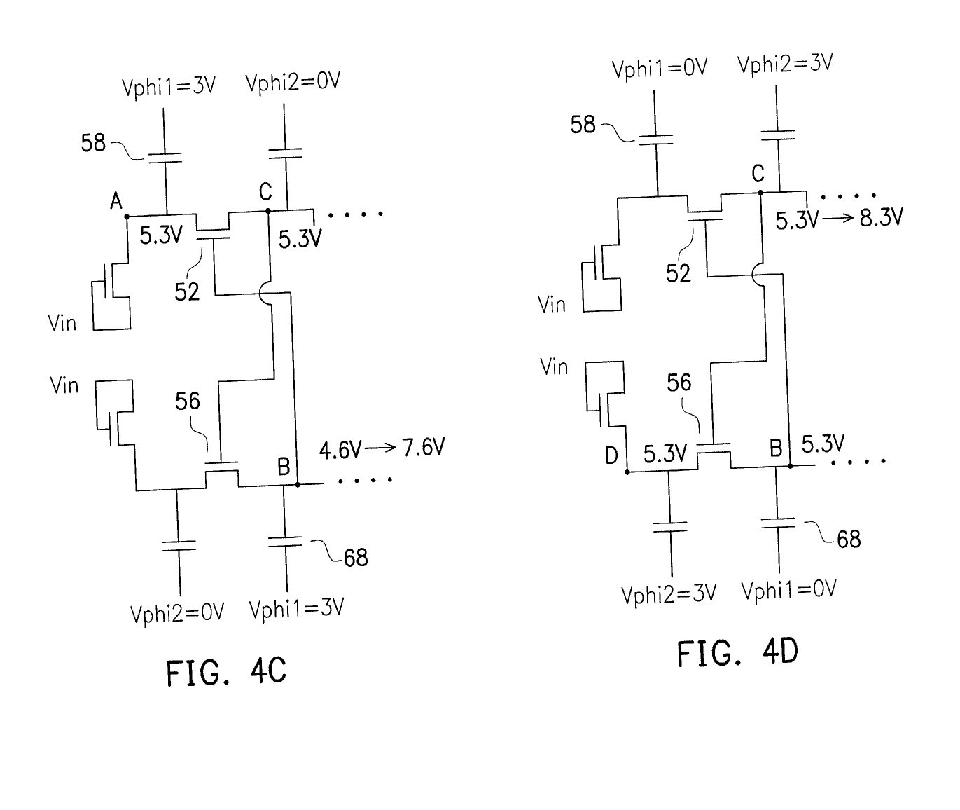

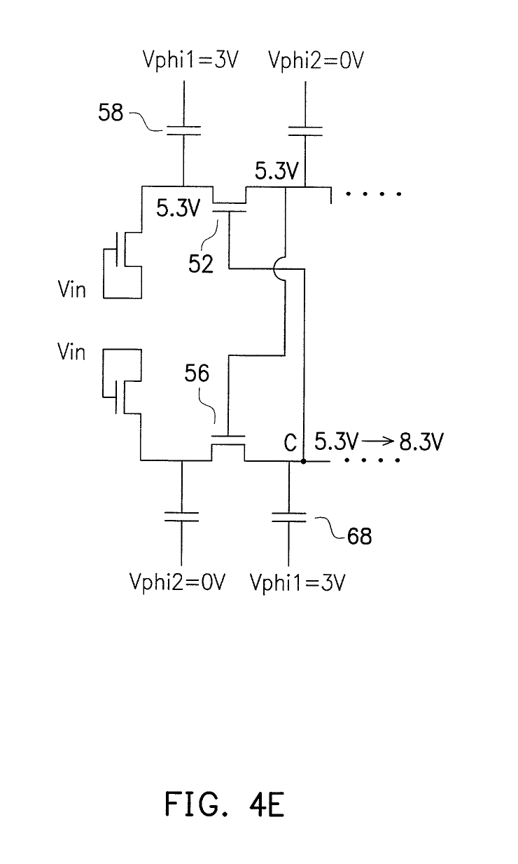

FIGS. 4A to 4E are a series of circuit diagrams showing the front end operating stages of the charge pumping circuit shown in FIG. 3. Here, input voltage is assumed to be Vin=3V and the first clocking signal Vphi1 and the second clocking signal Vphi2 both has an amplitude voltage of Vdd=3V. First, as shown in FIG. 4A, an input voltage Vin=3V is applied. Effected by a high voltage at the first clocking signal Vphi1, the first coupled capacitor 58 charges so that point A (the drain terminal of the NMOS transistor 52) of the first pull-up circuit section 30 is increased to 2.3+3=5.3V. Meanwhile, connection between the gate terminal of the NMOS transistor 52 and the source terminal of the NMOS transistor 56 leads to the coupling of the capacitor 68 so that point B changes from 0V to 3V. Because the 3V at the gate terminal of the NMOS transistor 52 is smaller than the 6V at the drain terminal, voltage at the source terminal is unable to attain a voltage (6V) identical to the drain terminal when the NMOS transistor is fully conductive. Hence, the source terminal (point C) of the NMOS transistor 52 has a voltage that is 0.7V smaller than the gate voltage (that is, the voltage is 3−0.7=2.3V).

As shown in FIG. 4B, a high voltage at the second clocking signal Vphi2 terminal charges the coupled capacitor 66 so that the original voltage 2.3V at point C is increased to 2.3+3=5.3V. This voltage is transmitted to the gate terminal of the NMOS transistor 56. An input voltage Vin−3V and a high voltage at the second clocking signal Vphi2 terminal charges the second coupled capacitor 62 so that voltage at point D (the drain terminal of the NMOS transistor 56) of the second pull-up circuit section 32 is changed to 2.3+3=5.3V. Since the 5.3V at the gate terminal (point C) of the NMOS transistor 56 is smaller than the 6V at the drain terminal (point D), voltage at the source terminal (point B) is unable to reach the drain voltage (6V) when the NMOS transistor 52 is fully conductive. Hence, the source terminal (point B) of the NMOS transistor 56 has a voltage that is 0.7V smaller than the gate voltage (that is, the voltage is 5.3−0.7=4.6V).

As shown in FIG. 4C, a high voltage at the first clocking signal Vphi1 terminal and the source terminal (point B) of the NMOS transistor 56 at a voltage of 4.6V charges the coupled capacitor 68 to a voltage 4.6+3=7.6V. In the meantime, the high voltage at the first clocking signal Vphi1 terminal also charges the first coupled capacitor 58 so that voltage at point A (the drain terminal of the NMOS transistor 52) of the first pull-up circuit section 30 changes to 2.3+3=5.3V. In this case, the 7.6V at the gate terminal of the NMOS transistor 52 is greater than the 6V at the drain terminal. Hence, the NMOS transistor 52 is filly conductive and the source terminal (point C) is at 5.3V.

As shown in FIG. 4D, a high voltage at the second clocking signal Vphi2 terminal charges the coupled capacitor 66 so that voltage at point C rises to 5.3+3=8.3V. This voltage is transmitted to the gate terminal of the NMOS transistor 56. Since the 8.3V at the gate terminal is higher than the 5.3V at the drain terminal (point D) of the NMOS transistor 56, the NMOS transistor 56 is fully conductive. Voltage at the drain terminal (point B) is changed to 5.3V and gradually stabilized.

As shown in FIG. 4E, the operation when the first clocking signal Vphi1 changes back to a high voltage is similar to the one already described in FIG. 4C. Aside from a voltage change at the gate of the NMOS transistor 52 voltage to 5.3V+3V=8.3V, which is different from the 7.6V in FIG. 4C, voltages at other part of the circuit are identical. After the passing of the transient state, operating states shown in FIG. 4D and 4E are repeated in cycles. Consequently, each stage is able to provide a stable voltage. Hence, a lowering of pull-up efficiency due to body effect in a conventional drain/gate connection structure can be avoided.

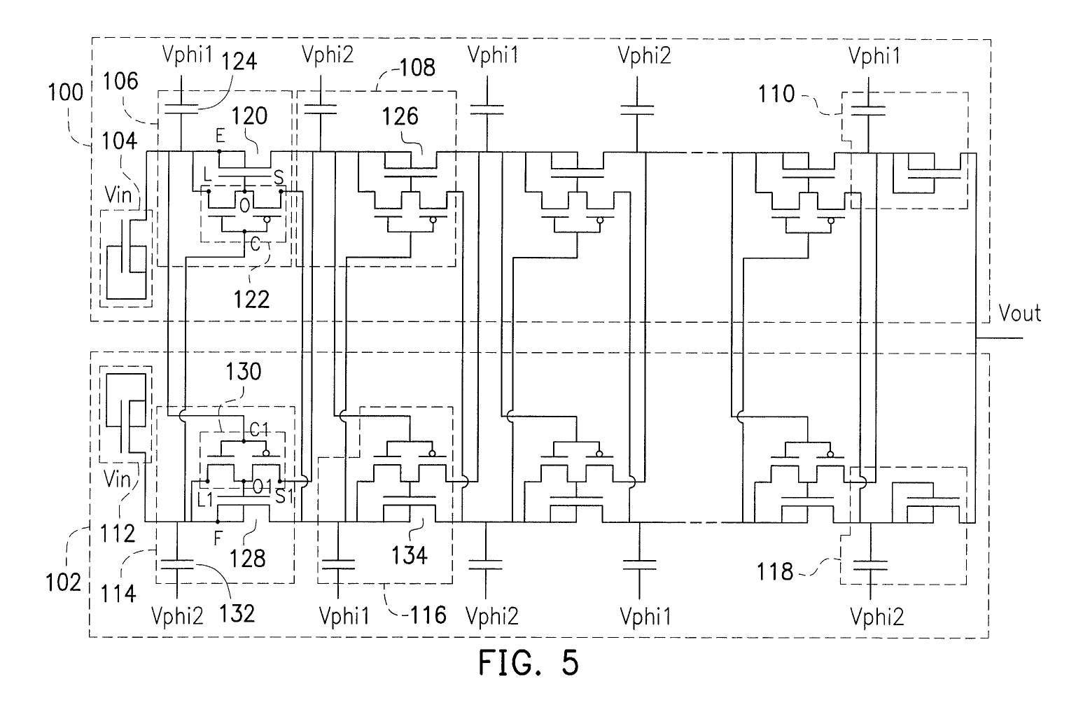

FIG. 5 is schematic diagram of a charge pumping circuit according to a second preferred embodiment of this invention. The charge pumping circuit comprises a first pull-up circuit section 100 and a second pull-up circuit section 102. The first pull-up circuit section 100 further includes a first input stage circuit 104, a plurality of first group pull-up circuit (such as 106 and 108) and a first output stage circuit 110. Similarly, the second pull-up circuit section 102 includes a second input stage circuit 112, a plurality of second group pull-up circuit (such as 114 and 116) and a second output stage circuit 118.

Circuit connections between the first input stage circuit 104, the first output stage circuit 110, the second input stage circuit 112 and the second output stage circuit 118 are identical to the circuit connections between the first input stage circuit 34, the first output stage circuit 40, the second input stage circuit 44 and the second output stage circuit 48 shown in FIG. 3. One major difference is that the substrate terminal and the drain terminal of the NMOS transistors are connected together while the substrate terminals of the NMOS transistors in FIG. 3 are connected to ground. Hence, a surface channel serving as an additional pathway (that is, a PN diode is formed between the substrate and the source terminal) for increasing operating speed is provided. Here, description of structurally identical connections is omitted. Only the non-identical first group pull-up circuits (106 and 108) and second group pull-up circuits (114 and 116) are further explained below.

The first group pull-up circuit 106 comprises an NMOS transistor 120, a CMOS circuit 122 and a first coupled capacitor 124. The drain terminal (point E) of the NMOS transistor 120 is connected to its substrate terminal, one terminal of the first coupled capacitor 124 and a loading terminal (point L) of the CMOS circuit 122. The source terminal of the NMOS transistor 120 is serially connected to the drain terminal of a corresponding NMOS transistor 126 in the next stage. The gate terminal of the NMOS transistor 120 is connected to an output terminal (point O) of the CMOS circuit 122. In addition, a control terminal (point C) of the CMOS circuit 122 is connected to the drain terminal of a corresponding NMOS transistor 128 in the second group pull-up circuit 114. A voltage terminal (point S) of the CMOS circuit 122 is connected to the source terminal of the corresponding NMOS transistor 128 in the second group pull-up circuit 114. The other terminal of the first coupled capacitor 124 receives a first clocking signal Vphi1.

The second group pull-up circuit 114 comprises the NMOS transistor 128, a CMOS circuit 130 and a second coupled capacitor 132. The drain terminal (point F) of the NMOS transistor 128 is connected to its substrate terminal, one terminal of the second coupled capacitor 132 and a loading terminal (point L1) of the CMOS circuit 130. The source terminal of the NMOS transistor 128 is serially connected to the drain terminal of a corresponding NMOS transistor 134 in the next stage. The gate terminal of the NMOS transistor 128 is connected to an output terminal (point O1) of the CMOS circuit 130. In addition, a control terminal (point C1) of the CMOS circuit 130 is connected to the drain terminal of the corresponding NMOS transistor 120 in the first group pull-up circuit 106. A voltage terminal (point S) of the CMOS circuit 130 is connected to the source terminal of the corresponding NMOS transistor 120 in the first group pull-up circuit 106. The other terminal of the second coupled capacitor 132 receives a second clocking signal Vphi2.

The first clocking signal Vphi1 is applied to all odd-numbered (1, 3, 5, . . . ) first coupled capacitor of the first group pull-up circuit (for example, 106) and to all even-numbered (2, 4, 6, . . . ) first coupled capacitor of the second group pull-up circuit (for example, 116). Similarly, the second clocking signal Vphi2 is applied to all even-numbered (2, 4, 6 . . . ) first coupled capacitor of the first group pull-up circuit (for example, 108) and to all odd-numbered (1, 3, 5, . . . ) first coupled capacitor of the second group pull-up circuit (for example, 114). Timing diagram of the first and the second clocking signal is similar to the one shown in FIG. 2. In other words, the first clocking signal Vphi1 and the second clocking signal Vphi2 are non-overlapping complementary signals.

Method of operation of the circuit in FIG. 5 is similar to one in FIG. 3 but more efficient. Hence, a detailed description of circuit operation other than major differences is omitted here. Because the drain terminal and the substrate terminal of the NMOS transistors are connected together, a PN diode is formed between the substrate and the source terminal aside from the original channel provided by the NMOS transistor. Furthermore, voltage at the gate terminal of the NMOS transistor is controlled by the CMOS circuit (NMOS+PMOS transistor). This ensures that the NMOS transistor always operates in the linear region and never moves into the saturated region within which the threshold voltage is increased due to body effect. In addition, the circuit shown in FIG. 5 can be designed inside a separated p-well within the deep n-well of a P-type substrate.

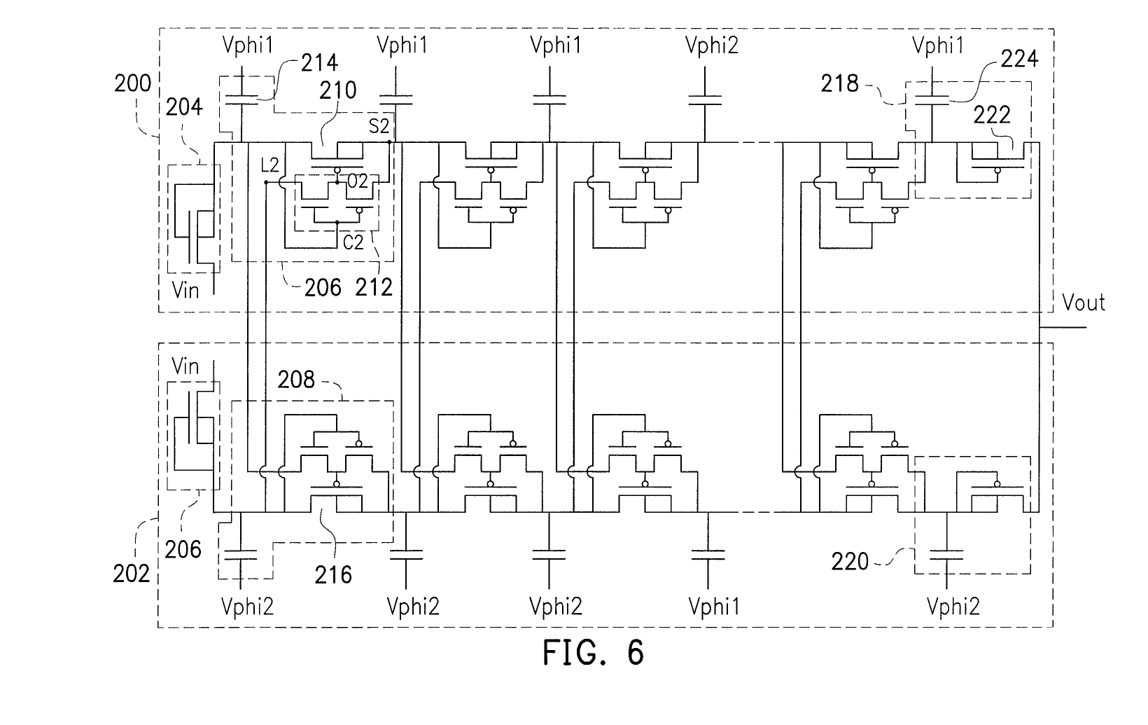

FIG. 6 is schematic diagram of a charge pumping circuit according to a third preferred embodiment of this invention. The circuit shown in FIG. 6 is very similar to the second embodiment of this invention (shown in FIG. 5). In the third embodiment, however, the circuit is designed on a detached p-well within a deep p-well of an n-type substrate. The circuit structure also includes a first pull-up circuit section 200 and a second pull-up circuit section 202. The first input stage circuit 204 and the second input stage circuit 205 is constructed using PMOS transistors. The source terminal of the PMOS transistor receives an input voltage Vin. The drain terminal and the gate terminal of PMOS transistor within the first input stage circuit 204 and the first group pull-up circuit 206 are connected together. Similarly, the drain terminal and the gate terminal of PMOS transistor within the second input stage circuit 205 and the second group pull-up circuit 208 are connected together.

The first group pull-up circuit 206 and the second group pull-up circuit 208 (using the first group pull-up circuit 206 as an example) each comprises a PMOS transistor 210, a CMOS circuit 212 and a first coupled capacitor 214. The PMOS transistor 210 in FIG. 6 replaces the NMOS transistor 120 in FIG. 5. The source terminal of the PMOS transistor 210 is connected to a control terminal (C2) of the CMOS circuit 212 and one terminal of the first coupled capacitor 214. The drain terminal of the PMOS transistor is connected to its substrate terminal and a voltage terminal (S2) of the CMOS circuit 212. The drain terminal of the PMOS transistor 210 is serially connected to the source terminal of a PMOS transistor in the next stage. The gate terminal of the PMOS transistor 210 is connected to an output terminal (point O2) of the CMOS circuit 212. A loading terminal (L2) of the CMOS circuit 212 in the first group pull-up circuit 200 is connected to the source terminal of a corresponding PMOS transistor 216 in the second group pull-up circuit 202. Similarly, a loading terminal of the CMOS circuit in the second group pull-up circuit 202 is connected to the source terminal of a corresponding PMOS transistor in the first group pull-up circuit 200.

The first clocking signal Vphi1 is applied to all odd-numbered first coupled capacitor of the first group pull-up circuit and to all even-numbered first coupled capacitor of the second group pull-up circuit. Similarly, the second clocking signal Vphi2 is applied to all even-numbered first coupled capacitor of the first group pull-up circuit and to all odd-numbered first coupled capacitor of the second group pull-up circuit. The first clocking signal Vphi1 and the second clocking signal Vphi2 are non-overlapping complementary signals.

The first output stage circuit 218 and the second output stage circuit 220 (using the first output stage circuit 218 as an example) each comprises a PMOS transistor 222 and a second coupled capacitor 224. The source terminal of the PMOS transistor 222 is connected to one terminal of the second coupled capacitor 224. The source terminal, the substrate terminal and the gate terminal of the PMOS transistor 222 are connected together. The drain terminal of the first output stage circuit 218 and the second output stage circuit 220 are connected together to form an output terminal. The other terminal of the second coupled capacitor of the first output stage circuit and the second output stage circuit are connected to receive the first clocking signal Vphi1 and the second clocking signal Vphi2, respectively.

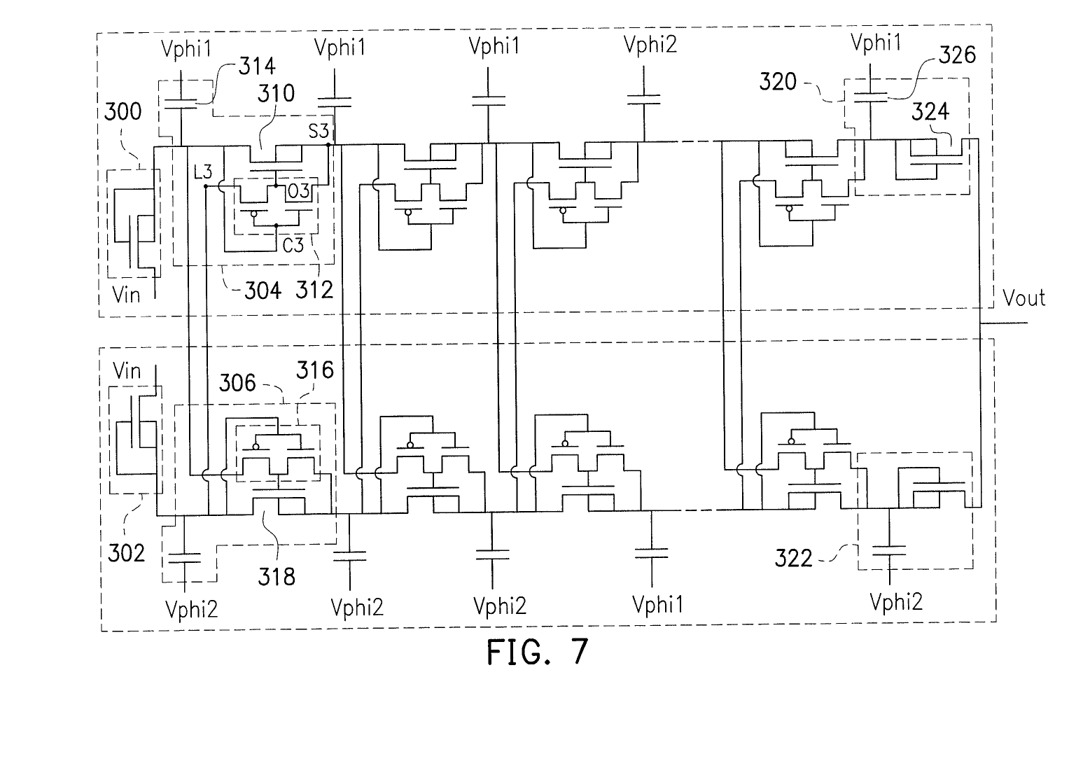

FIG. 7 is schematic diagram of a charge pumping circuit according to a fourth preferred embodiment of this invention. Since the circuit in FIG. 7 is to provide a larger negative voltage, a ground GND voltage is applied to the input terminal. The first input stage circuit 300 and the second input stage circuit 302 is constructed using an NMOS transistor. The drain terminal of each NMOS transistor is connected to the ground GND while its source terminal and its gate terminal are connected together. The source terminal of the input NMOS transistors are connected to a first group pull-up circuit 304 and a second group pull-up circuit 306, respectively.

The first group pull-up circuit 304 and the second group pull-up circuit 306 (using the first group pull-up circuit 304 as an example) each comprises an NMOS transistor 310, a CMOS circuit 312 and a first coupled capacitor 314. The drain terminal of the NMOS transistor 310 is connected to a control terminal (C3) of the CMOS circuit 312 and one terminal of the first coupled capacitor 314. The source terminal of the NMOS transistor 310 is connected to its substrate terminal and a loading terminal (L3) of the CMOS circuit 312. The source terminal of the NMOS transistor 310 is serially connected to the drain terminal of a corresponding NMOS transistor in the next stage. The gate terminal of the NMOS transistor 310 is connected to an output terminal (O) of the CMOS circuit 312. A voltage terminal (S3) of the CMOS circuit 312 in the first group pull-up circuit 304 is connected to the drain terminal of a corresponding NMOS transistor 318 in the second group pull-up circuit 306. Similarly, a voltage terminal of the CMOS circuit 316 in the second group pull-up circuit 306 is connected to the drain terminal of a corresponding NMOS transistor 310 in the first group pull-up circuit 304.

The first clocking signal Vphi1 is applied to all odd-numbered first coupled capacitor of the first group pull-up circuit and to all even-numbered first coupled capacitor of the second group pull-up circuit. Similarly, the second clocking signal Vphi2 is applied to all even-numbered first coupled capacitor of the first group pull-up circuit and to all odd-numbered first coupled capacitor of the second group pull-up circuit. The first clocking signal Vphi1 and the second clocking signal Vphi2 are non-overlapping complementary signals.

The first output stage circuit 320 and the second output stage circuit 322 (using the first output stage circuit 320 as an example) each comprises an NMOS transistor 324 and a second coupled capacitor 326. The drain terminal of the NMOS transistor 324 is connected to one terminal of the second coupled capacitor 326. The drain terminal, the substrate terminal and the gate terminal of the NMOS transistor 324 are connected together. The source terminal of the first output stage circuit 320 and the second output stage circuit 322 are connected together to form an output terminal. The other terminal of the second coupled capacitor of the first output stage circuit and the second output stage circuit are connected to receive the first clocking signal Vphi1 and the second clocking signal Vphi2, respectively.

In summary, this invention avoids body effect due to the connection between the drain terminal and the gate terminal of a transistor in a conventional design so that overall performance of the charge pumping circuit is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A charge pumping circuit, comprising:
a first pull-up circuit section having a first input stage circuit, a plurality of first group pull-up circuits and a first output stage circuit; and
a second pull-up circuit section having a second input stage circuit, a plurality of second group pull-up circuit and a second output stage circuit;
wherein a terminal of the first input stage circuit and a terminal of the second input stage circuit receive an input voltage while other terminals of the first input stage circuit and the second input stage circuit are connected to the first group pull-up circuit to and the second group pull-up circuit, respectively;
each first group pull-up circuit and each second group pull-up circuit comprises an NMOS transistor and a first coupled capacitor, wherein a drain terminal of the NMOS transistor is connected to one terminal of the first coupled capacitor, a source terminal of the NMOS transistor is serially connected to a drain terminal of a corresponding NMOS transistor in a next stage, a gate terminal of the NMOS transistor in the first group pull-up circuit is connected to a source terminal of a corresponding NMOS transistor in the second group pull-up circuit, a gate terminal of the NMOS transistor in the second group pull-up circuit is connected to a source terminal of a corresponding NMOS transistor in the first group pull-up circuit, a first clocking signal is applied to other terminals of all odd-numbered first coupled capacitors in the first group pull-up circuits and all even-numbered first coupled capacitors in the second group pull-up circuits, a second clocking signal is applied to other terminals of all even-numbered first coupled capacitors in the first group pull-up circuits and all odd-numbered second coupled capacitors in the second group pull-up circuits, and the first clocking signal and the second clocking signal are non-overlapping complementary signals; and
the first output stage circuit and the second output stage circuit each comprise an output NMOS transistor and a second coupled capacitor, wherein a drain terminal of the NMOS transistor is connected to a gate terminal thereof and one terminal of the second coupled capacitor, a source terminal of the NMOS transistor in the first output stage circuit and a source terminal of the second output stage circuit are connected together to serve as an output terminal, and another terminal of the second coupled capacitor of the first output stage circuit and another terminal of the second coupled capacitor of the second output stage are connected to receive the first clocking signal and the second clocking signal, respectively.

2. The charge pumping circuit of claim 1, wherein the first input stage circuit and the second input stage circuit are respectively constructed using an NMOS transistor, a drain terminal and a gate terminal of the NMOS transistor receive the input voltage, the source terminal of the NMOS transistor in the first input stage circuit and the NMOS transistor in the second input stage circuit are connected to the drain terminal of the first NMOS transistor of the first group pull-up circuit and the first NMOS transistor of the second group pull-up circuit, respectively.

3. A charge pumping circuit, comprising:
a first pull-up circuit section having a first input stage circuit, a plurality of first group pull-up circuits and a first output stage circuit; and
a second pull-up circuit section having a second input stage circuit, a plurality of second group pull-up circuits and a second output stage circuit,
wherein a terminal of the first input stage circuit and a terminal of the second input stage circuit receive an input voltage while another terminal of the first input stage circuit and the second input stage circuit are connected to the first group pull-up circuit and the second group pull-up circuit, respectively;
each first group pull-up circuit and each second group pull-up circuit comprises an NMOS transistor, a CMOS circuit and a first coupled capacitor, wherein a drain terminal of the NMOS transistor is connected to a substrate thereof, one terminal of the first coupled capacitor and a loading terminal of the CMOS circuit, the source terminal of each NMOS transistor is serially connected to a drain terminal of an NMOS transistor in the next stage, a gate terminal of the NMOS transistor is connected to an output terminal of the CMOS circuit, a control terminal of the CMOS circuit in the first group pull-up circuit is connected to a drain terminal of a corresponding NMOS transistor in the second group pull-up circuit, a voltage terminal of the CMOS circuit in the first group pull-up circuit is connected to a source terminal of a corresponding NMOS transistor in the second group pull-up circuit, a voltage terminal of the CMOS circuit in the second group pull-up circuit is connected to a source terminal of a corresponding NMOS transistor in the first group pull-up circuit, a first clocking signal is applied to other terminals of all odd-numbered first coupled capacitors in the first group pull-up circuits and all even-numbered first coupled capacitors in the second group pull-up circuits, a second clocking signal is applied to other terminals of all even-numbered first coupled capacitors in the first group pull-up circuits and all odd-numbered second coupled capacitors in the second group pull-up circuits, and the first clocking signal and the second clocking signal are non-overlapping complementary signals; and
the first output stage circuit and the second output stage circuit each comprise an output NMOS transistor and a second coupled capacitor, wherein a drain terminal of the NMOS transistor is connected to a substrate thereof, a gate terminal of the NMOS transistor and one terminal of the second coupled capacitor, a source terminal of the NMOS transistor in the first output stage circuit and a source terminal of the NMOS transistor in the second output stage circuit are connected together to serve as an output terminal, another terminal of the second coupled capacitor of the first output stage circuit and another terminal of the second coupled capacitor of the second output stage are connected to receive the first clocking signal and the second clocking signal, respectively.

4. The charge pumping circuit of claim 3, wherein the first input stage circuit and the second input stage circuit are respectively constructed using an NMOS transistor, wherein a drain terminal and a gate terminal of the NMOS transistor receive the input voltage, the source terminal of the NMOS transistor in the first input stage circuit and the NMOS transistor in the second input stage circuit are connected to the drain terminal of the first NMOS transistor of the first group pull-up circuit and the first NMOS transistor of the second group pull-up circuit, respectively.

5. The charge pumping circuit of claim 3, wherein the CMOS circuit comprises a PMOS circuit and an NMOS circuit, wherein a gate terminal of the PMOS transistor and a gate terminal of the NMOS transistor are connected together to serve as the control terminal, the drain terminal of the PMOS transistor and the NMOS transistor are connected together to serve as the output terminal, a source terminal of the PMOS transistor serves as the voltage terminal and a source terminal of the NMOS transistor serves as the loading terminal.

6. A charge pumping circuit, comprising:
a first pull-up circuit section having a first input stage circuit, a plurality of first group pull-up circuit and a first output stage circuit; and
a second pull-up circuit section having a second input stage circuit, a plurality of second group pull-up circuit and a second output stage circuit;
wherein a terminal of the first input stage circuit and a terminal of the second input stage circuit receive an input voltage while other terminals of the first input stage circuit and the second input stage circuit are connected to the first group pull-up circuit and the second group pull-up circuit, respectively;
each first group pull-up circuit and each second group pull-up circuit comprises a PMOS transistor, a CMOS circuit and a first coupled capacitor, wherein a source terminal of the PMOS transistor is connected to a control terminal of the CMOS circuit and one terminal of the first coupled capacitor, a drain terminal of the PMOS transistor is connected to a substrate terminal thereof and a voltage terminal of the CMOS circuit, the drain terminal of each PMOS transistor is serially connected to a source terminal of a corresponding PMOS transistor in the next stage, a gate terminal of the PMOS transistor is connected to an output terminal of the CMOS circuit, a loading terminal of the CMOS circuit in the first group pull-up circuit is connected to a source terminal of a corresponding PMOS transistor in the second group pull-up transistor, a loading terminal of the CMOS circuit in the second group pull-up circuit is connected to a source terminal of a corresponding PMOS transistor in the first group pull-up transistor, a first clocking signal is applied to other terminals of all odd-numbered first coupled capacitors in the first group pull-up circuits and all even-numbered first coupled capacitors in the second group pull-up circuits, a second clocking signal is applied to the terminals of all even-numbered first coupled capacitors in the first group pull-up circuits and all odd-numbered second coupled capacitors in the second group pull-up circuits, and the first clocking signal and the second clocking signal are non-overlapping complementary signals; and
the first output stage circuit and the second output stage circuit each comprise an output PMOS transistor and a second coupled capacitor, wherein a source terminal of the PMOS transistor is connected to one terminal of the second coupled capacitor, the source terminal of the PMOS transistor is connected to a substrate terminal thereof, a gate terminal thereof and one terminal of the second coupled capacitor, the drain terminal of the PMOS transistor in the first output stage circuit and the drain terminal of the PMOS transistor in the second output stage circuit are connected together to serve as an output terminal, another terminal of the second coupled capacitor of the first output stage circuit and another terminal of the second coupled capacitor of the second output stage are connected to receive the first clocking signal and the second clocking signal, respectively.

7. The charge pumping circuit of claim 6, wherein the first input stage circuit and the second input stage circuit are respectively constructed using a PMOS transistor, wherein a source terminal of the PMOS transistor receives the input voltage, a drain terminal of the PMOS transistor in the first input stage circuit and a PMOS transistor in the second input stage circuit are connected to respective gate terminals thereof and the first PMOS transistor of the first group pull-up circuit and the first PMOS transistor of the second group pull-up circuit, respectively.

8. The charge pumping circuit of claim 7, wherein the CMOS circuit comprises a PMOS circuit and an NMOS circuit, wherein gate terminals of the PMOS transistor and the NMOS transistor are connected together to serve as the control terminal, drain terminals of the PMOS transistor and the NMOS transistor are connected together to serve as the output terminal, a source terminal of the PMOS transistor serves as the voltage terminal and a source terminal of the NMOS transistor serves as the loading terminal.

9. A charge pumping circuit, comprising:
a first pull-up circuit having a first input stage circuit, a plurality of first group pull-up circuit and a first output stage circuit; and
a second pull-up circuit having a second input stage circuit, a plurality of second group pull-up circuit and a second output stage circuit;
wherein a terminal of the first input stage circuit and a terminal of the second input stage circuit receive an input voltage while other terminals of the first input stage circuit and the second input stage circuit are connected to the first group pull-up circuit and the second group pull-up circuit, respectively;
each first group pull-up circuit and each second group pull-up circuit comprises an NMOS transistor, a CMOS circuit and a first coupled capacitor, wherein a drain terminal of the NMOS transistor is connected to a control terminal of the CMOS circuit and one terminal of the first coupled capacitor, a source terminal of the NMOS transistor is connected to its substrate terminal and a loading terminal of the CMOS circuit, a source terminal of each NMOS transistor is serially connected to the drain terminal of a corresponding NMOS transistor in the next stage, a gate terminal of the NMOS transistor is connected to an output terminal of the CMOS circuit, a voltage terminal of the CMOS circuit in the first group pull-up circuit is connected to a drain terminal of a corresponding NMOS transistor in the second group pull-up transistor, a voltage terminal of the CMOS circuit in the second group pull-up circuit is connected to a drain terminal of a corresponding NMOS transistor in the first group pull-up transistor, a first clocking signal is applied to other terminals of all odd-numbered first coupled capacitors in the first group pull-up circuits and all even-numbered first coupled capacitors in the second group pull-up circuits, a second clocking signal is applied to other terminals of all even-numbered first coupled capacitors in the first group pull-up circuits and all odd-numbered second coupled capacitors in the second group pull-up circuits, and the first clocking signal and the second clocking signal are non-overlapping complementary signals; and
the first output stage circuit and the second output stage circuit each comprise an output NMOS transistor and a second coupled capacitor, wherein a drain terminal of the NMOS transistor is connected to one terminal of the second coupled capacitor, the drain terminal of the NMOS transistor is also connected to a substrate terminal and a gate terminal thereof, the source terminal of the NMOS transistor in the first output stage circuit and the source terminal of the NMOS transistor in the second output stage circuit are connected together to serve as an output terminal, other terminal of the second coupled capacitor of the first output stage circuit and another terminal of the second coupled capacitor of the second output stage are connected to receive the first clocking signal and the second clocking signal, respectively.

10. The charge pumping circuit of claim 9, wherein the first input stage circuit and the second input stage circuit are respectively constructed using an NMOS transistor, wherein a drain terminal of the NMOS transistor receives a ground voltage, a source terminal of the NMOS transistor in the first input stage circuit and a source terminal of the NMOS transistor in the second input stage circuit are connected to gate terminals thereof, respectively, and the first NMOS transistor of the first group pull-up circuit and the first NMOS transistor of the second group pull-up circuit, respectively.

11. The charge pumping circuit of claim 9, wherein the CMOS circuit comprises a PMOS circuit and an NMOS circuit, wherein a gate terminal of the PMOS transistor and a gate terminal of the NMOS transistor are connected together to serve as the control terminal, a drain terminal of the PMOS transistor and a drain terminal of the NMOS transistor are connected together to serve as the output terminal, a source terminal of the PMOS transistor serves as the voltage terminal and a source terminal of the NMOS transistor serves as the loading terminal.
